(19) United States
(12) Patent Application Publication
(10) Pub. No.: US 2013/0243943 A1
(43) Pub. Date: Sep. 19, 2013

(54) POROUS SOLID BACKBONE IMPREGNATION FOR ELECTROCHEMICAL ENERGY CONVERSION SYSTEMS

(71) Applicants: Samir BOULFRAD, Thuwal (SA); Ghassan Jabbour, Thuwal (SA)

(72) Inventors: Samir BOULFRAD, Thuwal (SA); Ghassan Jabbour, Thuwal (SA)

(21) Appl. No.: 13/781,248

(22) Filed: Feb. 28, 2013

Related U.S. Application Data
(60) Provisional application No. 61/605,317, filed on Mar. 1, 2012.

(51) Int. Cl. H01M 8/02

(52) U.S. Cl. CPC H01M 8/0291
USPC 427/115; 118/697

(57) ABSTRACT

An apparatus and method for impregnating a porous solid backbone. The apparatus may include a platform for holding a porous solid backbone, an ink jet nozzle configured to dispense a liquid solution onto the porous solid backbone, a positioning mechanism configured to position the ink jet nozzle proximate to a plurality of locations of the porous solid backbone, and a control unit configured to control the positioning mechanism to position the ink jet nozzle proximate to the plurality of locations and cause the ink jet nozzle to dispense the liquid solution onto the porous solid backbone.

### CROSS REFERENCE TO RELATED APPLICATIONS

This application claims priority to U.S. Provisional Patent Application No. 61/605,317 to Samir Boulfrad et al., filed on Mar. 1, 2012, and entitled “Apparatus and Method for Porous Solid Backbone Impregnation for Electrochemical Energy Conversion Systems,” which is hereby incorporated by reference.

### BACKGROUND OF THE INVENTION

1. Field of the Invention

This invention relates to electrochemical energy conversion systems and more particularly relates to an apparatus and method for impregnation of porous solid backbones, which may be used as electrodes in electrochemical energy conversion systems.

2. Description of the Related Art

Solid Oxide Fuel Cells (SOFCs) and Solid Oxide Electrolysis Cells (SOECs) are electrochemical devices for power generation and energy conversion. Cells are typically made of two porous electrodes (anode & cathode) separated by a ceramic electrolyte. The electrodes are requested to be chemically and thermally compatible with the electrolyte, and electronic and ionic conductors. The electrodes should provide sufficient transport of gas by means of continuous open porosity. Furthermore, electrode materials should present catalytic activity towards the desired electrode reaction. Classically, electrodes are porous composite materials containing an ionic conductive phase and an electronic conductive phase presenting the desired catalytic activity. The electrode reactions happen on the Triple Phase Boundaries (TPB) at the interface between the three phases: the ionic conductive, the electronic conductive, and the gaseous phases in the pores. Better electrode performances are obtained with electrodes presenting larger TPB.

In SOFCs, oxygen is usually reduced on the cathode side. The produced oxygen ions are transported through a dense ionic conductor electrolyte to the anode side where they react with protons to form water. The protons are the product of hydrogen oxidation in the anode side, the released electrons go through an external connection to the cathode side.

FIG. 1 shows an electrode 100 of the prior art. Active material 108 is distributed among a porous solid backbone 106 between an electrolyte 104 and a current conductor 102. The areas of contact between the active material 108, backbone 106 and the gas that surround them create the TPB 110.

### SUMMARY OF THE INVENTION

A method for impregnating a porous solid backbone is presented. The method in the disclosed embodiments substantially includes the steps necessary to carry out the functions presented below with respect to the operation of the described apparatus. In one embodiment, the apparatus includes providing a porous solid backbone and dispensing a liquid solution onto the porous solid backbone using an ink jet nozzle. In some embodiments, the liquid solution may include an active material and a solvent. The liquid solution may include an organic compound or precursors to an active material. In addition, the method may include providing physicochemical treatment to the porous solid backbone.

In some embodiments, the ink jet nozzle may be a piezoelectric ink jet nozzle. The nozzle can be heated while operating to influence the physical properties of the liquid solution. In addition, the method may include heating the porous solid backbone before the solution is dispensed on the porous solid backbone. In some embodiments, the porous solid backbone may be heated during and/or after the solution is dispensed on the porous solid backbone. Furthermore, in some embodiments, the method may include providing additional physicochemical treatment to the porous solid backbone to a temperature sufficient to cause the solvent to evaporate, organic components to decompose, and the active material to crystallize on the porous solid backbone. In some embodiments, the physicochemical treatment may be sufficient to cause the active material to crystallize in a given solid phase symmetry. In some embodiments, the physicochemical treatment involves providing heat from room temperature up to 1000° C. or higher. In some cases, additional apparatus like, hot plates, ovens and furnaces may be used to crystallize the coated material.

In some embodiments, the method may include positioning the ink jet nozzle proximate to a first location of the porous solid backbone and causing the ink jet nozzle to dispense a portion of the liquid solution onto the porous solid backbone at the first location. In addition, in some embodiments, the method may include positioning the ink jet nozzle proximate to a second location of the porous solid backbone and causing the ink jet nozzle to dispense an additional portion of the liquid solution onto the porous solid backbone at the second location. In some embodiments, the portion of the liquid solution dispensed at the first location partially overlaps with the portion of the liquid solution dispensed at the second location.

In some embodiments, the ink jet nozzle may be repositioned in a plurality of locations proximate to the porous solid backbone, and the plurality of locations may be substantially in a straight line to produce a row of locations. In addition, the ink jet nozzle may be repositioned in a plurality of locations proximate to the porous solid backbone in a second row of locations, to create columns of positions. The rows and columns may substantially cover a surface of the porous solid backbone. Furthermore, the locations in the rows and columns partially overlap with adjacent positions. In some embodiments, the method include adjusting the speed of positioning the ink jet nozzle from the first location to the second location. In addition, in some embodiments, the method may include heating the liquid solution prior to causing the ink jet nozzle to dispense the liquid solution.

In some embodiments, the porous solid backbone is an anode of a solid oxide fuel cell. The porous solid backbone may also be an anode of a solid oxide electrolysis cell. In some embodiments, the porous solid backbone is a cathode of a solid oxide fuel cell and/or solid oxide electrolysis cell.

Tangible computer-readable media are also presented. A tangible computer-readable medium may include computer-readable instructions, that when executed by a computer, perform at least one embodiment of the methods presented herein. The tangible computer-readable medium may be, for example, a CD-ROM, a DVD-ROM, a flash drive, a hard drive or any other physical memory storage device.

In some methods, a tangible computer-readable medium is created. In some embodiments, the method may include recording the computer readable medium with computer readable code that, when executed by a computer, causes the computer to perform at least one embodiment of the present methods disclosed herein. Recording the computer readable medium may include, for example, burning data onto a CD-ROM or a DVD-ROM, or otherwise populating a physical storage device with the data.

An apparatus is also presented. In some embodiments, the apparatus may include a platform for holding a porous solid backbone, and an ink jet nozzle configured to dispense a liquid solution onto the porous solid backbone. In addition, the apparatus may include a positioning mechanism configured to position the ink jet nozzle proximate to a plurality of locations of the porous solid backbone. In some embodiments, the apparatus may include a control unit configured to control the positioning mechanism to position the ink jet nozzle proximate to the plurality of locations and cause the ink jet nozzle to dispense the liquid solution onto the porous solid backbone. Also, the apparatus may include a first heater configured to heat the platform. In some embodiments, the control unit may be configured to provide physicochemical treatment to the backbone.

In some embodiments, the control unit may be further configured to position the ink jet nozzle proximate to a first location of the porous solid backbone. In addition, the control unit may be configured to cause the ink jet nozzle to dispense a portion of the liquid solution onto the porous solid backbone at the first location. Also, the control unit may be configured to position the ink jet nozzle proximate to a second location of the porous solid backbone. In some embodiments, the control unit may be configured to cause the ink jet nozzle to dispense an additional portion of the liquid solution onto the porous solid backbone at the second location.

In some embodiments, the portion of the liquid solution dispensed at the first location partially overlaps with the portion of the liquid solution dispensed at the second location. In addition, the apparatus may include a second heater configured to heat the inkjet nozzle.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a diagram illustrating the 2D cross section distribution of active material within an electrode of the prior art.

FIG. 2 is a diagram illustrating the deposition of a solution on a porous solid backbone.

FIGS. 3 and 4 are diagrams illustrating the distribution of active material within an electrode of the present disclosure.

FIG. 5 is a schematic block diagram of apparatus for impregnating a porous solid backbone.

FIG. 6 is a flow chart showing the steps of one embodiment of a method for impregnating a porous solid backbone.

FIG. 7 is an image illustrating an “H” pattern of LSM printed on a YSZ porous structure according to one embodiment of the disclosure.

FIG. 8 is a graph illustrating an x-ray diffraction pattern showing the LSM crystal phase on the YSZ porous structure according to one embodiment of the disclosure.

FIG. 9 is an image illustrating LSM nanoparticles coating the YSZ porous structure according to one embodiment of the disclosure.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

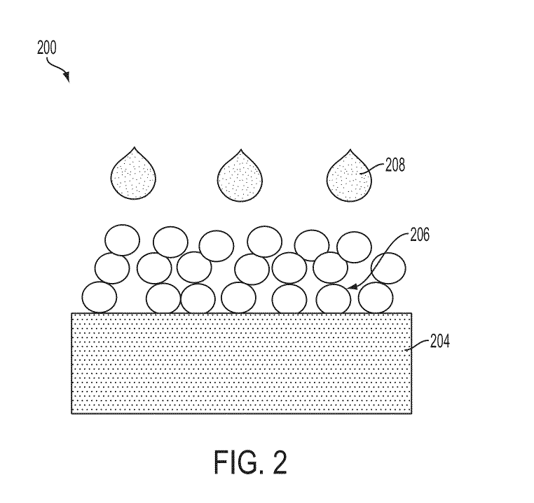

FIG. 2 illustrates one embodiment of a system 200 for impregnating a porous solid backbone that may be used in an electrochemical energy conversion system. In one embodiment, the system 200 includes a dense electrolyte 204 and a porous solid backbone 206. The porous solid backbone 206 may be made of metal, ceramic, and/or glass. The pores may be micro-, meso-, or macropore size. Furthermore, the porous solid backbone may form the structure for an anode or a cathode of an SOFC or SOEC. System 200 also includes drops of solution 208 that are dispensed onto the backbone 206. The solution 208 includes a solvent and precursors of an active material, such as soluble salts. For example, the soluble salts may be nitrates or acetates. In some embodiments, solid particles of a coating material are dispersed in the solvent. In some embodiments, the solution may contain organic components such as dispersants, binders and/or plasticizers.

Several materials may be used with the methods of this disclosure. For example, the porous solid backbone may be made of porous yttria-stabilized zirconia (YSZ); gadolinia doped ceria (GDC) and metallic nickel foams. The active material may include different electrode materials such as oxides (La₁₋ₓSrₓMnO₃ (LSM), La₁₋ₓSrₓCo_{1-y}Fe_{y}O₃ (LSCF), La₁₋ₓSrₓCr_{1-y}Mn_{y}O₃ (LSCM), La₁₋ₓSrₓNi_{1-y}Ti_{y}O₃ (LSNT), NbTi_{0.5}Ni_{0.5}O₄ (NTNO), catalysts (Ni, Pd, Pt, Ru, Fe, Ce), and/or ceramics. The active material contributes to the catalytic activity of the electrode. The porous solid backbone may be made from ionic conductor materials. In some embodiments the materials cited above as active materials can be used as the material for the porous solid backbone, and materials cited as backbone materials can be used as coating active phases.

Although not shown in FIG. 2, the drops of solution 208 are dispensed using an ink jet nozzle. In some embodiments the ink jet nozzle may be a piezoelectric ink jet. The ink jet nozzle allows the system to precisely and accurately dispense a controlled amount of solution onto the porous solid backbone 206. The solution 208 then impregnates the porous solid backbone 206. Because the solution 208 contains an active material, the active material is distributed throughout the porous solid backbone 206. The solvent in the solution 208 may then evaporate, leaving the active material behind. Because the solution is selectively deposited onto the porous solid backbone, some of the methods described herein permit anodes and cathodes to be impregnated with different materials. In addition, because the solution is precisely deposited onto the backbone, less solution is required to impregnate a backbone, which reduces cost and waste.

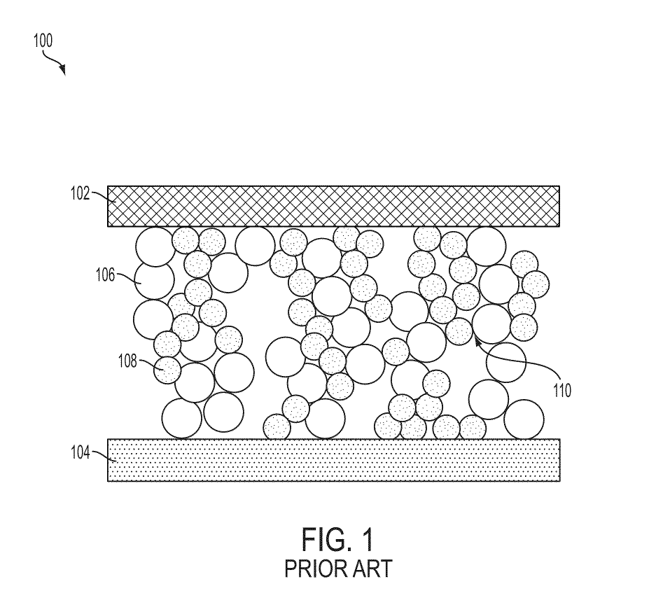

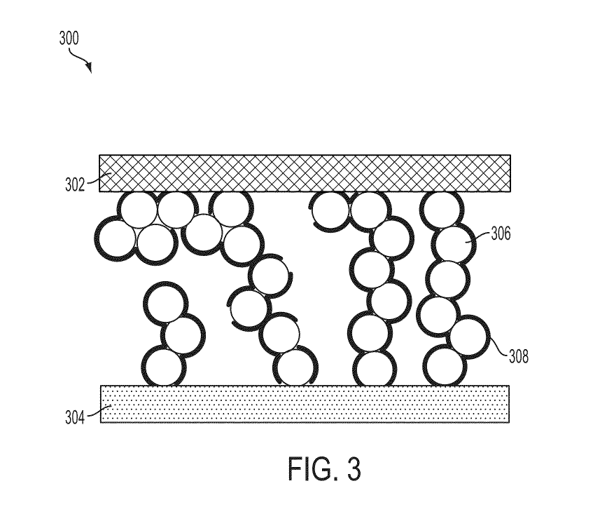

FIG. 3 shows a portion of a SOFC electrode 300, where the porous solid backbone has been impregnated with a solution 208. The porous solid backbone includes particles 306 that have spaces between them. The porous solid backbone is formed on a dense electrolyte 304. In this figure, a solution 208, as discussed in connection with FIG. 2, has been dispensed on the porous solid backbone 306 and the backbone has subsequently received physicochemical treatment that causes the solvent to evaporate and/or organic components to decompose. In some embodiments the physicochemical treatment may cause the active material to crystallize in a desired solid phase symmetry. What is left behind is the active material 308 that coats the porous solid backbone 306. Compared to the electrode shown in FIG. 1, the electrode in FIG. 3 has a more even distribution of active material, which may result in increased Triple Phase Boundary. An increase in Triple Phase Boundary may result in increased efficiency of the SOFC/SOEC, for example. The current collector 302 is an electrical contact that makes contact with the electrode containing the solid backbone and allows for an electrical connection.

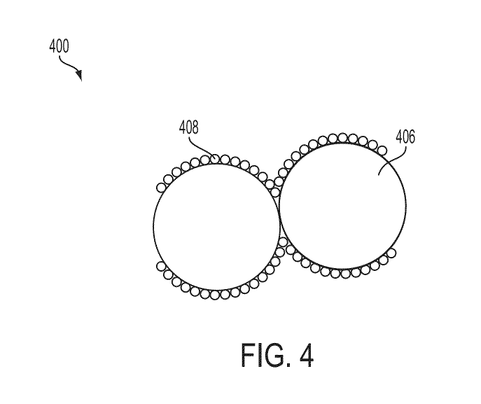

FIG. 4 shows a portion of a porous solid backbone in detail. The figure shows two individual backbone particles 406 of a porous solid backbone 400. As seen in this figure, the active material particles 408 partially line the perimeter of the backbone particles 406. In reality, the electrode particle 408 is a three-dimensional object and the active material particles would at least partially surround the surface of the backbone particle. The distribution of active material particles 408 is the result of impregnating the porous solid backbone 206 with a solution 208 using an ink jet nozzle, as discussed in connection with FIG. 2. After proper physicochemical treatment, the active material particles 408 remain on the backbone particles 406. In this embodiment, the active material particles 408 are smaller than the backbone particles 406, which may allow for an increased Triple Phase Boundary. The size difference may cause a greater amount of surface area of the electrode particles 406 that is exposed to the active material particles 408.

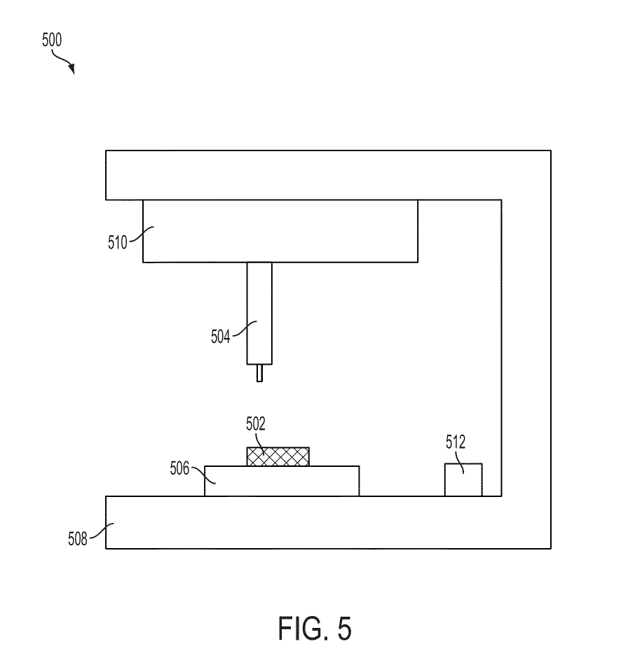

FIG. 5 shows an apparatus 500 for impregnating an electrode. The apparatus 500 includes a housing 508. A platform 506 is configured to hold a porous solid backbone 502. Also connected to the housing 508 is a positioning mechanism 510 configured to position an ink jet nozzle 504 proximate to the porous solid backbone 502. The ink jet nozzle 504 is configured to dispense a liquid solution onto the porous solid backbone 502. The liquid solution 208 was described above in connection with FIG. 2.

The positioning mechanism 510 is configured to position the ink jet nozzle 504 proximate to a plurality of locations of the porous solid backbone.

Apparatus 500 may also include a control unit 512 that is configured to control the positioning mechanism 510 to position the ink jet nozzle 504 proximate to the plurality of locations on the porous solid backbone 502. The control unit may include electronics such as a processor and memory. In some embodiments, the control unit 512 may include a PC computer that is programmed to control the positioning system 510 and the ink jet nozzle 504. The control unit 512 may cause the ink jet nozzle 504 to dispense liquid solution onto the porous solid backbone 502.

The positioning system 510 may be used to position the ink jet nozzle 504 over the surface of the porous solid backbone 502. In some embodiments, the positioning system 510 may be configured to move the ink jet nozzle 504 in two orthogonal directions. In other embodiments, the positioning system 510 may move the ink jet nozzle 504 in first direction and the platform 506 may move the porous solid backbone 502 in a second direction, where the second direction is orthogonal to the first direction. In either case, the ink jet nozzle 504 may be positioned over at least a portion of the surface of the porous solid backbone.

The apparatus 500 may be configured to impregnate the porous solid backbone 502 by positioning the ink jet nozzle 504 over a first location of the porous solid backbone and causing the ink jet nozzle 504 to dispense a portion of liquid solution onto the porous solid backbone 502. The apparatus 500 may then position the ink jet nozzle 504 over a second location of the porous solid backbone 502 and cause the ink jet nozzle 504 to dispense an additional portion of the liquid solution onto the porous solid backbone 502 at the second location. This process may be repeated until at least a portion of the surface of the porous solid backbone 502 is impregnated. In some embodiments, the locations where the solution is dispensed are positioned to cause the solution dispensed at two adjacent locations to overlap. The overlap may ensure that the solution is dispensed evenly over the porous solid backbone, and may be used to control the depth of impregnation and the thickness of the active coating material.

The ink jet nozzle 504 may be positioned in rows and columns over the porous solid backbone 502. The rows and columns may be helpful to accurately dispense the solution onto the porous solid backbone 502.

The platform 506 may also include a heater that is configured to heat the porous solid backbone 502. Heat treatment affects the evaporation of the solvent, and it may be controlled to help establish a precise 3D distribution of active material on the porous solid backbone. In some embodiments, an additional apparatus may be used to provide heating up to 1000° C. or higher to ensure the crystallinity of the active material. The heating rate, temperature, time and atmosphere may affect the crystallinity and morphology of the active material, or the coating phase.

Many factors may contribute to the distribution of the solution onto, and into, the porous solid backbone. For example, in some embodiments, the solution may be heated prior to being dispensed onto the porous solid backbone 502. A solution may become less viscous at higher temperatures, which may allow the solution to penetrate, or impregnate, the porous solid backbone. The nature of the components of the liquid solution can influence the evaporation rate and the wettability of the solid porous backbone by the solution. In addition, the control unit 512 may control the speed of positioning the ink jet nozzle 504 over the porous solid backbone. Some of these factors may allow for the control of depth of impregnation as well as the reproducibility of the impregnation.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

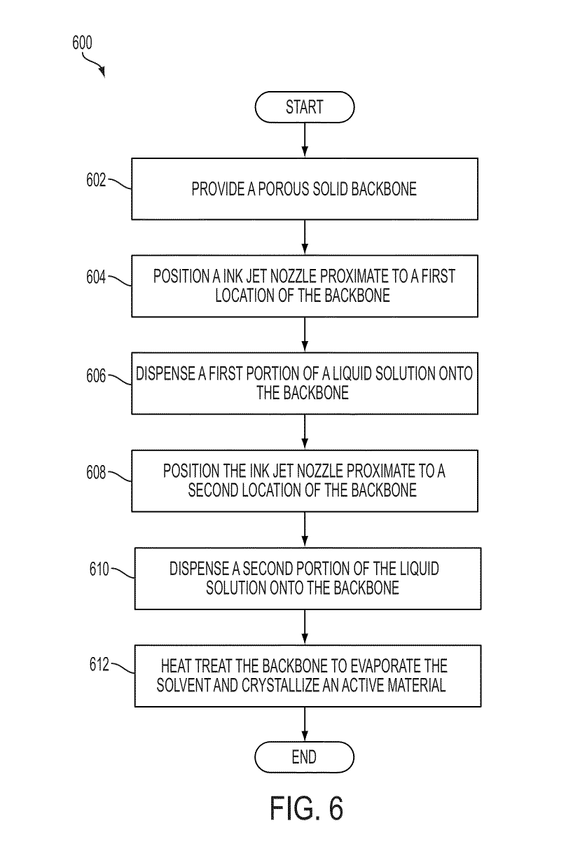

FIG. 6 illustrates one embodiment of a method 600 for impregnating a solid porous electrode for electrochemical energy conversion systems. In one embodiment, the method 600 starts at step 602, which is to provide a porous solid backbone. The porous solid backbone was described above in connection with FIGS. 2-5.

Method 600 continues to step 604, which is to position an ink jet nozzle proximate to a first location of the electrode. The ink jet nozzle may be moved into position by moving the nozzle relative to the electrode, moving the electrode relative to the nozzle, or a combination of both. At step 606, a first portion of a liquid solution is dispensed onto the electrode. The liquid solution was described above in connection with FIG. 2, and contains a solvent and an active material or precursor of an active material.

At step 608, the ink jet nozzle is positioned proximate to a second location of the electrode. In some embodiments the ink jet nozzle may be positioned proximate to locations that make up rows and columns on the surface of the electrode. Using this method, the surface of the electrode may be evenly coated or impregnated with the solution. After the ink jet nozzle is positioned over the second location, at step 610 a second portion of the liquid solution is dispensed onto the electrode. Finally, at step 612, the impregnated backbone is heat treated, which may occur in or on a given heat source such as an oven with or without controlled atmosphere. The solvent evaporates and an active material is left crystallized on the porous solid backbone.

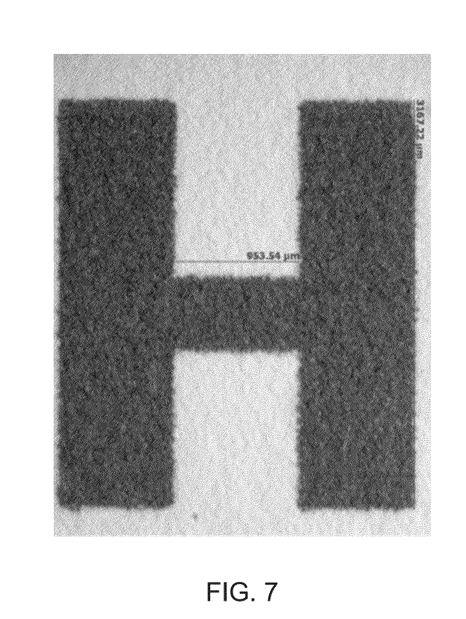

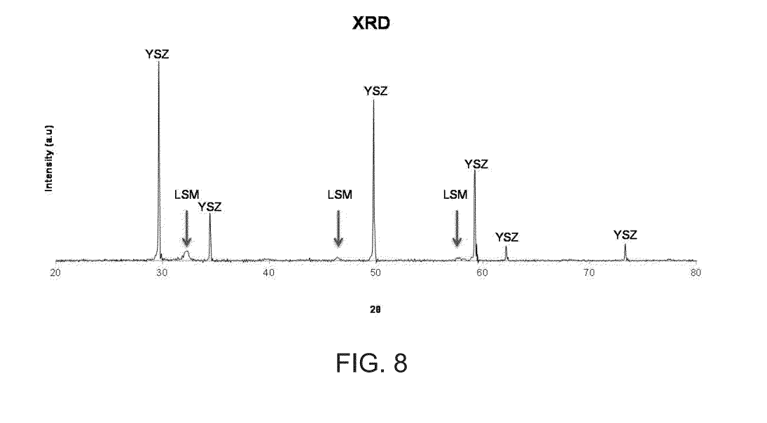

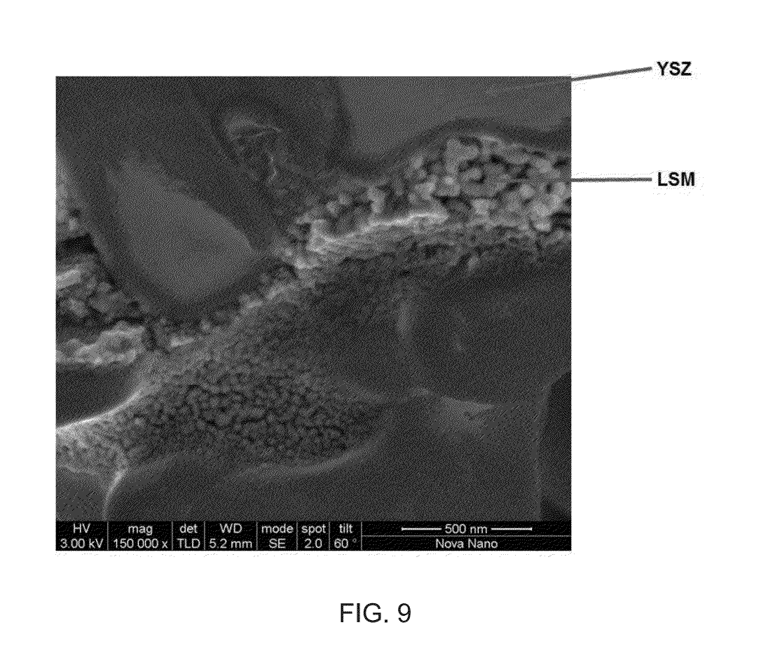

FIG. 7 is an image illustrating an “H” pattern of LSM printed on a YSZ porous structure according to one embodiment of the disclosure. The deposited “H” pattern of FIG. 7 may be deposited according to the methods disclosed above, in which the porous solid backbone may be made of porous yttria-stabilized zirconia (YSZ) and the active material may include an electrode materials such as La₁₋ₓSrₓMnO₃ (LSM). FIG. 8 is a graph illustrating an x-ray diffraction pattern showing the LSM crystal phase on the YSZ porous structure according to one embodiment of the disclosure. FIG. 9 is an image illustrating LSM nanoparticles coating the YSZ porous structure according to one embodiment of the disclosure.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. For example, in some embodiments, the ink jet nozzle may be made to dispense solution before the nozzle reaches the second position because of the time it takes for the solution to reach the electrode that the time it takes the nozzle to reach the second location. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method comprising:
providing a porous solid backbone;
dispensing a liquid solution onto the porous solid backbone using an ink jet nozzle, where the liquid solution comprises a solvent and a first material, and where the first material comprises an active material or a precursor of an active material; and
providing physicochemical treatment to the porous solid backbone.

2. The method of claim 1, where the ink jet nozzle is a piezoelectric ink jet nozzle.

3. The method of claim 1, further comprising providing additional physicochemical treatment to the porous solid backbone to cause the solvent to evaporate, an organic component to decompose, and the active material to crystallize on the porous solid backbone.

4. The method of claim 1, where dispensing the liquid solution comprises:
positioning the ink jet nozzle proximate to a first location of the porous solid backbone;
causing the ink jet nozzle to dispense a portion of the liquid solution onto the porous solid backbone at the first location;
positioning the ink jet nozzle proximate to a second location of the porous solid backbone; and
causing the ink jet nozzle to dispense an additional portion of the liquid solution onto the porous solid backbone at the second location.

5. The method of claim 4, where the portion of the liquid solution dispensed at the first location partially overlaps with the portion of the liquid solution dispensed at the second location.

6. The method of claim 4, where the ink jet nozzle is repositioned in a plurality of locations proximate to the porous solid backbone and where the plurality of locations are substantially in a straight line to produce a row of locations.

7. The method of claim 6 where the ink jet nozzle is repositioned in a plurality of locations proximate to the porous solid backbone in a second row of locations, to create columns of positions.

8. The method of claim 7, where the locations in the rows and columns partially overlap with adjacent positions.

9. The method of claim 1, where the porous solid backbone and active material form an electrode of a solid oxide fuel cell or a solid oxide electrolysis cell.

10. The method of claim 1, where the porous solid backbone and active material form a cathode of a solid oxide fuel cell.

11. The method of claim 4, further comprising adjusting the speed of positioning the ink jet nozzle from the first location to the second location.

12. The method of claim 6, further comprising heating the liquid solution prior to causing the ink jet nozzle to dispense the liquid solution and heating of the porous solid backbone before, during and after dispensing the liquid solution.

13. A tangible computer-readable medium comprising computer-readable instructions that, when executed by a computer, perform operations comprising:
dispensing with an ink jet nozzle a liquid solution onto a porous solid backbone, where the liquid solution comprises a solvent, organic components and a first material, and where the first material comprises an active material or precursor of an active material; and
heating the porous solid backbone to a temperature sufficient to cause evaporation of the solvent, decomposition of the organic components and crystallization of the active material on the porous solid backbone.

14. The tangible computer-readable medium of claim 13 comprising computer-readable instructions, that when executed by a computer, perform operations comprising:
positioning the ink jet nozzle proximate to a first location of the porous solid backbone;
causing the ink jet nozzle to dispense a portion of the liquid solution onto the porous solid backbone at the first location;
positioning the ink jet nozzle proximate to a second location of the porous solid backbone; and
causing the ink jet nozzle to dispense an additional portion of the liquid solution onto the porous solid backbone at the second location.

15. The tangible computer-readable medium of claim 14 comprising computer-readable instructions, that when executed by a computer, perform operations further comprising where the portion of the liquid solution dispensed at the first location partially overlaps with the portion of the liquid solution dispensed at the second location.

16. The tangible computer-readable medium of claim 14 comprising computer-readable instructions, that when executed by a computer, perform operations further comprising heating the inkjet nozzle or the porous solid backbone.

17. An apparatus for impregnating a porous solid backbone, comprising:
a platform for holding a porous solid backbone;
an ink jet nozzle configured to dispense a liquid solution onto the porous solid backbone;
a positioning mechanism configured to position the ink jet nozzle proximate to a plurality of locations of the porous solid backbone;
a control unit configured to control the positioning mechanism to position the ink jet nozzle proximate to the plurality of locations and cause the ink jet nozzle to dispense the liquid solution onto the porous solid backbone;
a first heater configured to heat the platform.

18. The apparatus of claim 17, where the control unit is further configured to:
position the ink jet nozzle proximate to a first location of the porous solid backbone;
cause the ink jet nozzle to dispense a portion of the liquid solution onto the porous solid backbone at the first location;
position the ink jet nozzle proximate to a second location of the porous solid backbone; and
cause the ink jet nozzle to dispense an additional portion of the liquid solution onto the porous solid backbone at the second location.

19. The apparatus of claim 18, where the portion of the liquid solution dispensed at the first location partially overlaps with the portion of the liquid solution dispensed at the second location.

20. The apparatus of claim 17, further comprising a second heater configured to heat the ink jet nozzle.
